(19) United States
(12) Patent Application Publication
(10) Pub. No.: US 2010/0302162 A1
(43) Pub. Date: Dec. 2, 2010

(54) KEYBOARD INPUT DEVICE CAPABLE OF KEY COLOR ADJUSTING AND KEY COLOR ADJUSTING METHOD USING THEREOF

(76) Inventor: Jang-Yeon Jo, Gyeonggi-do (KR)

Correspondence Address: SHERR & VAUGHN, PLLC, 620 HERNDON PARKWAY, SUITE 320, HERNDON, VA, 20170, US

(21) Appl. No.: 12/526,281

(22) PCT Filed: Feb. 5, 2008
(86) PCT No.: PCT/KR08/00745

§ 371 Date: Aug. 7, 2009

(30) Foreign Application Priority Data
Feb. 7, 2007 (KR) 10-2007-0012860

(51) Int. Cl. G06F 3/02

(52) U.S. Cl. 345/168

(57) ABSTRACT

An object of the present invention is to provide a keyboard input device and a method of selecting a color of a key that can use existing key color setting without installing a drive program even when a connected unit such as a computer, an IPTV, or a set-top box is replaced. In order to achieve the object, a keyboard input device according to the present invention includes a plurality of keys that is made of a transparent material and connected to a computer, an IPTV and the like. The keyboard input device includes light-emitting elements that are provided below the plurality of keys and each include a plurality of LEDs for illuminating upper surfaces of the keys, a microcomputer that controls the colors of the light-emitting elements by controlling the plurality of LEDs, and a color adjusting unit that is connected to the mi- crocomputer and adjusts the colors of the keys by adjusting the colors of the plurality of LEDs.

### TECHNICAL FIELD

The present invention relates to a keyboard input device, and more particularly, to a keyboard input device and a method of adjusting a color of a key that can independently select a color of a keyboard by using illumination below the keyboard.

### BACKGROUND ART

The following technology has been known. In connection with a keyboard input device including several keys, such as a computer keyboard, a keyboard for an IPTV, or a remote control, each of the keys is made of a transparent material and a light-emitting element capable of displaying a color is provided on the bottom of each key in order to illuminate the key.

In order to adjust the color of the key, a separate drive program for adjusting a color of the keyboard input device and displaying the adjusted color is installed on the computer or the IPTV, and the color of the key is selected by the program while a user sees the color displayed on the computer or the IPTV.

For this reason, there has been an inconvenience that a color-adjustment drive program should be separately installed on the computer or the IPTV and executed. It is relatively easy to additionally install a program on a computer, but it is difficult to additionally install a program on an IPTV or a set-top box that has already released. Although a program can be installed on the IPTV or the set-top box, there is a problem in that the installation is very troublesome.

Further, there is the following problem. If a computer, IPTV, or set-top box is replaced due to failure or replaced with a new product after colors of keys of the keyboard input device are selected on the existing computer, IPTV, or set-top box, a color selection program should be installed again and color selection should be performed with respect to all of the keys in the same way.

### DISCLOSURE OF INVENTION

### Technical Problem

The present invention has been made to solve the above-mentioned problems, and an object of the present invention is to provide a keyboard input device and a method of adjusting a color of a key that can maintain existing key color setting without installing a drive program even when a connected unit such as a computer, an IPTV, or a set-top box is replaced.

### TECHNICAL SOLUTION

In order to achieve the object, according to an embodiment of the present invention, a keyboard input device includes a plurality of keys that is connected to a computer, an IPTV and the like. The keyboard input device includes light-emitting elements that are provided below the plurality of keys and each include a plurality of LEDs for illuminating upper surfaces of the keys, a microcomputer that controls the colors of the light-emitting elements by controlling the plurality of LEDs, and a color adjusting unit that is connected to the microcomputer and adjusts the colors of the keys by adjusting the colors of the plurality of LEDs. The color adjusting unit includes an operation switch module that controls start and end of the color adjustment, a color adjusting switch module that adjusts colors of the LEDs, and a color display module that displays the colors adjusted by the color adjusting switch module.

In the keyboard input device, the operation switch module may include a start switch, an end switch, and a reset switch. Further, the color adjusting switch module may include a red-color adjusting switch, a green-color adjusting switch, and a blue-color adjusting switch that adjust the brightness of the colors. Furthermore, the color display module may include a display part that is made of a transparent material and a light-emitting element that includes a plurality of LEDs provided below the display part.

According to another embodiment of the present invention, a keyboard input device includes a plurality of keys that is connected to a computer, an IPTV and the like. The keyboard input device includes light-emitting elements that are provided below the plurality of keys and each include a plurality of LEDs for illuminating the upper surfaces of the keys, a microcomputer that controls the colors of the light-emitting elements by controlling the plurality of LEDs, and a color adjusting unit that is connected to the microcomputer and adjusts the colors of the keys by adjusting the colors of the plurality of LEDs. The color adjusting unit includes an operation switch module that controls start and end of the color adjustment, and a color display module that displays a color table of having various colors and selects colors.

In the keyboard input device, the operation switch module may include a start switch, an end switch, and a reset switch. Further, the color display module may be formed of a touch panel and a color is selected by touching a screen.

In the keyboard input device, the microcomputer and the color adjusting unit may be integrally formed with the keyboard input device.

In the keyboard input device, a color adjustment program for driving the color adjusting unit may be stored in the microcomputer.

According to another embodiment of the present invention, a method of selecting a color of a key by using the keyboard input device according to claim 1 includes a step (a) of inputting a key of which color is desired to be selected; a step (b) of adjusting a desired color of the input key by using the color adjusting unit, transmitting a signal corresponding to the adjusted color to the color display module, and adjusting the color while a user sees the displayed color; and a step (c) of controlling LEDs, which are provided to the key, by the microcomputer so that the adjusted color is displayed with respect to the input key.

According to another embodiment of the present invention, a method of selecting a color of a key by using the keyboard input device according to claim 3 includes a step (a) inputting a key of which color is desired to be selected; a step (b) selecting one color from the color table, which is displayed on the color adjusting unit, with respect to the input key; and a step (c) of controlling LEDs, which are provided to the key, by the microcomputer so that the selected color is displayed with respect to the input key.

In the method of selecting a color, the step (b) may be performed before the step (a).

### Advantageous Effects

The keyboard input device according to present invention can independently select and display colors of keys regardless of a connected unit such as a computer or an IPTV. Therefore, a separate drive program does not need to be installed and executed to select the colors of the keys.

Further, even when a connected unit such as a computer, an IPTV, or a set-top box is connected or replaced with a new product, a separate drive program does not need to be installed again and color selection does not need to be performed with respect to existing keys.

### BRIEF DESCRIPTION OF THE DRAWINGS

FIG. 1 is a view showing a keyboard input device according to the present invention.

FIG. 2 is a view showing the cross-section of a key of the present invention.

FIG. 3 is a view showing the configuration of a keyboard input device according to a first embodiment of the present invention.

FIG. 4 is a view showing the cross-sectional view of a color display module of the first embodiment of the present invention.

FIG. 5 is a view illustrating a method of selecting a color of each key in the first embodiment of the present invention.

FIG. 6 is a view illustrating another example of the method of selecting a color of each key in the first embodiment of the present invention.

FIG. 7 is a view showing the configuration of a keyboard input device according to a second embodiment of the present invention.

FIG. 8 is a view illustrating a method of selecting a color of each key in the second embodiment of the present invention.

### BEST MODE FOR CARRYING OUT THE INVENTION

Embodiments of the present invention will be described below with reference to accompanying drawings.

### First Embodiment

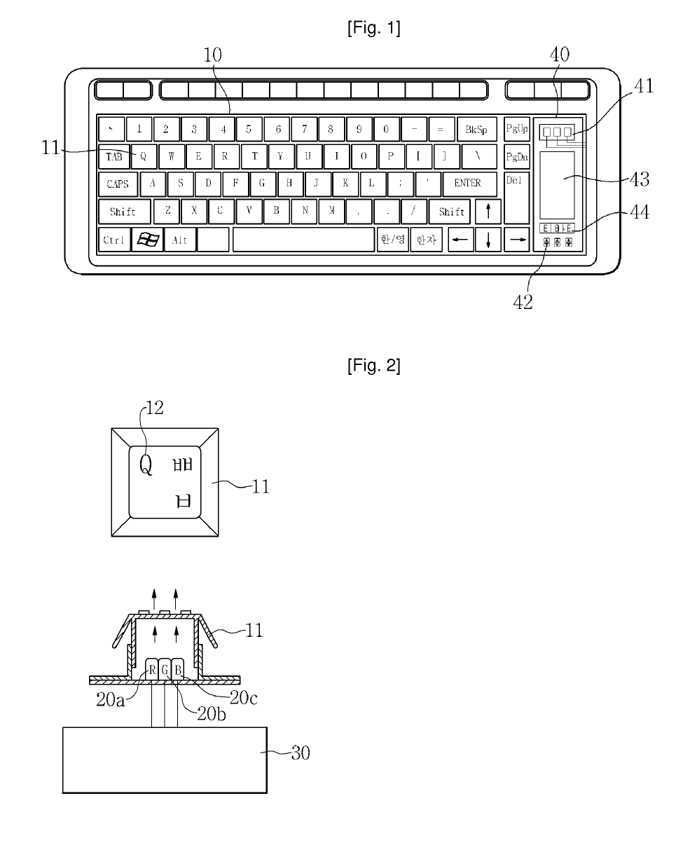

FIG. 1 is a view showing a keyboard input device according to an embodiment of the present invention.

A keyboard input device 1 according to the present invention includes a keyboard unit 10, a light-emitting element 20 that is provided below each key 11 of the keyboard unit 10, a microcomputer 30 that controls a color of the light-emitting element 20, and a color adjusting unit 40 that is connected to the microcomputer 30 and adjusts the color of the light-emitting element 20 corresponding to each key 11.

FIG. 2 is a view showing the cross-section of the key of the present invention.

The keyboard unit 10 includes a plurality of keys 11 that is made of a transparent material. Since opaque liquid is applied on the upper surface of the key 11 and only a letter portion 12 is removed by laser, light emitted from the light-emitting element 20 is transmitted through the letter portion 12.

Light is transmitted through the only letter portion 12 in the embodiment of the present invention, but the present invention is not limited thereto. That is, the key 11 may be made of a transparent material and the only letter portion 12 may be made opaque, so that a letter can be recognized.

The light-emitting element 20 is provided below each key 11. The light-emitting element 20 includes three (red (R), green (G), and blue (B)) LEDs 20a, 20b, and 20c. Each of the LEDs 20a, 20b, and 20c is connected to the microcomputer 30.

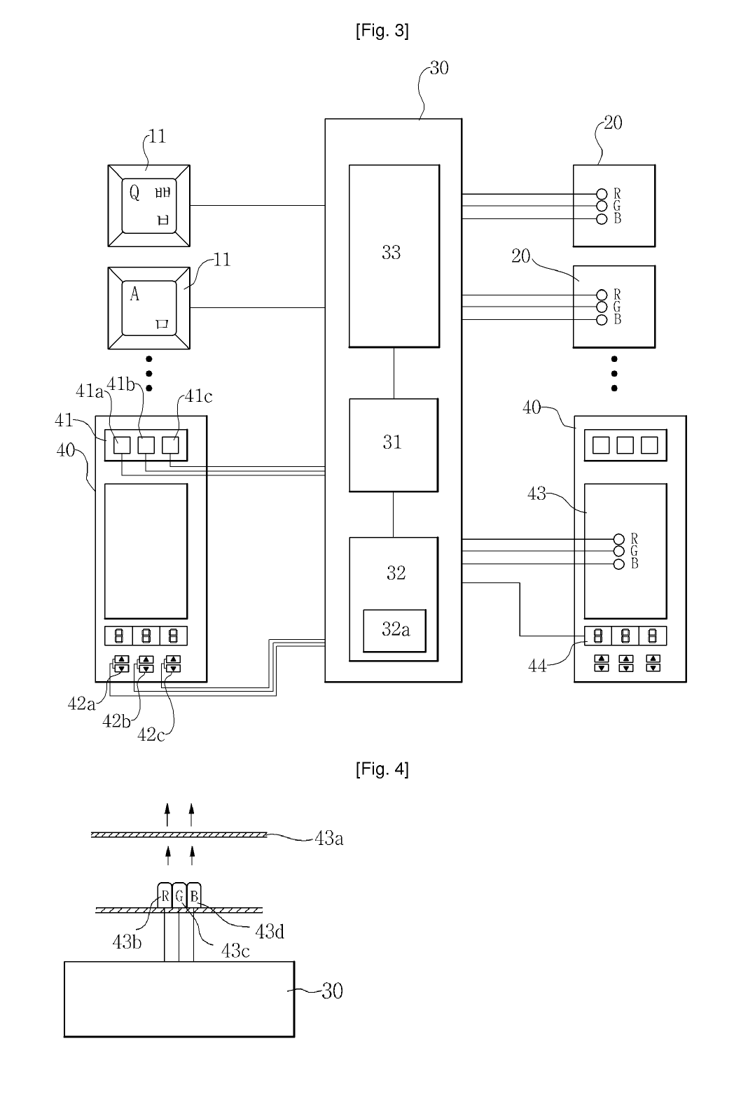

FIG. 3 is a view showing the configuration of the keyboard input device according to the present invention.

The microcomputer 30 is provided in the keyboard input device 1, and includes a central processing unit 31, a memory 32, and an I/O interface 33. The memory 32 includes a ROM and a RAM. A color adjustment program 32a for controlling the LEDs 20a, 20b, and 20c is stored in the ROM so that the color of the key to be adjusted by the color adjusting unit 40 is displayed on a color display module 43 and the adjusted color is displayed.

FIG. 4 is a view showing the cross-sectional view of the color display module of the first embodiment of the present invention.

The color adjusting unit 40 is a unit for adjusting the color of the key, and is integrally formed with the keyboard input device 1. The color adjusting unit includes an operation switch module 41, a color adjusting switch module 42, a color display module 43, and color-adjustment display modules 44.

The operation switch module 41 is connected to the microcomputer 30. The operation switch module includes a start switch 41a that is used to start the color adjustment of each key 11, an end switch 41b that is used to finish the color adjustment when the color adjustment is finished, and a reset switch 41c that is used to reset the selected color adjustment.

The color adjusting switch module 42 is a switch that is used to adjust the desired color of each key 11, and is connected to the microcomputer 30. The color adjusting switch module includes a red-color adjusting switch 42a, a green-color adjusting switch 42b, and a blue-color adjusting switch 42c. Each of the adjusting switches 42a, 42b, and 42c is provided with the color-adjustment display module 44.

Each of the adjusting switches 42a, 42b, and 42c is composed of increase and decrease buttons, and numerals are displayed on the color-adjustment display module 44 by the operation of the increase and decrease buttons in order to represent brightness. Accordingly, a user can easily select a color. If the numeral displayed on the color-adjustment display module 44 is 0, the color is not selected.

The color display module 43 includes a display part 43a that is made of a transparent material, and a plurality of LEDs 43b, 43c, and 43d that is provided below the display part 43a and connected to the microcomputer 30. This is a structure similar to the structure that displays the color of the key 11.

As the buttons of the adjusting switches 42a, 42b, and 42c are operated, the microcomputer 30 controls the plurality of LEDs 43b, 43c, and 43d so that a color is displayed by the display part 43a. This functions to display substantially the same color as the color displayed on the key 11.

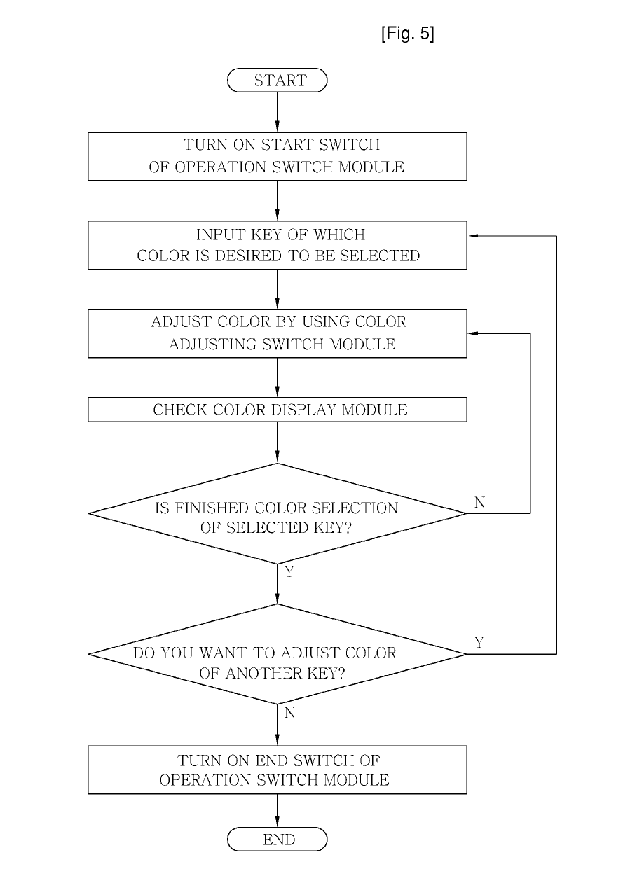

A method of selecting a color of each key 11 by using the color adjusting unit 40 will be described below. FIG. 5 is a view illustrating a method of selecting a color of each key in the present invention.

First, the start switch 41a of the operation switch module 41 is operated in the color adjusting unit 40 of the keyboard input device 1 according to the present invention (Step S1).

Then, a key 11 of which color is desired to be selected is pushed so that a signal corresponding to the key 11 is input to the microcomputer 30 (Step S2). In this case, if several keys 11 are pushed so that signals are input, the same color is input for the several keys 11.

After that, one or two or more of the red-color adjusting switch 42a, the green-color adjusting switch 42b, and the blue-color adjusting switch 42c of the color adjusting switch module 42 is(are) used to adjust a desired color (Step S3).

For example, if a green color is intended to be displayed, the only green-color adjusting switch 42b is turned on and the red-color adjusting switch 42a and the blue-color adjusting switch 42c are operated to be turned off so that each cerresponding numeral displayed on the color-adjustment display module 44 becomes 0.

Meanwhile, if the increase or decrease button of the green-color adjusting switch 42a is adjusted with respect to the green color, it is possible to select a green color having different brightness.

Further, in order to select a color different from the green color selected as described above, for example, the increase or decrease button of the red-color adjusting switch 42a may be adjusted so that a red color having appropriate brightness is mixed to the green color, thereby displaying a different green color.

If each of the red-color adjusting switch 42a, the green-color adjusting switch 42b, and the blue-color adjusting switch 42c, and each of the increase or decrease buttons thereof is adjusted in this ways, it is possible to select various colors through various combinations.

When the color is adjusted as described above, the color selected by the color adjusting switch module 42 is input to the microcomputer 30 and the color adjustment program 32a is executed. Accordingly, an adjusted color is displayed on the color display module 43, which makes a user easily select a color (Step S4).

When the color selection of the key 11 is finished (Step S5), the contents of the color selection of the former key are stored if another key is pushed to select a color of another key 11 (Step S6). Color adjustment is performed with respect to another key in the same way. Then, when the color adjustment is performed with respect to all of the desired keys, the end switch 42b is operated to finish the color adjustment (Step S7).

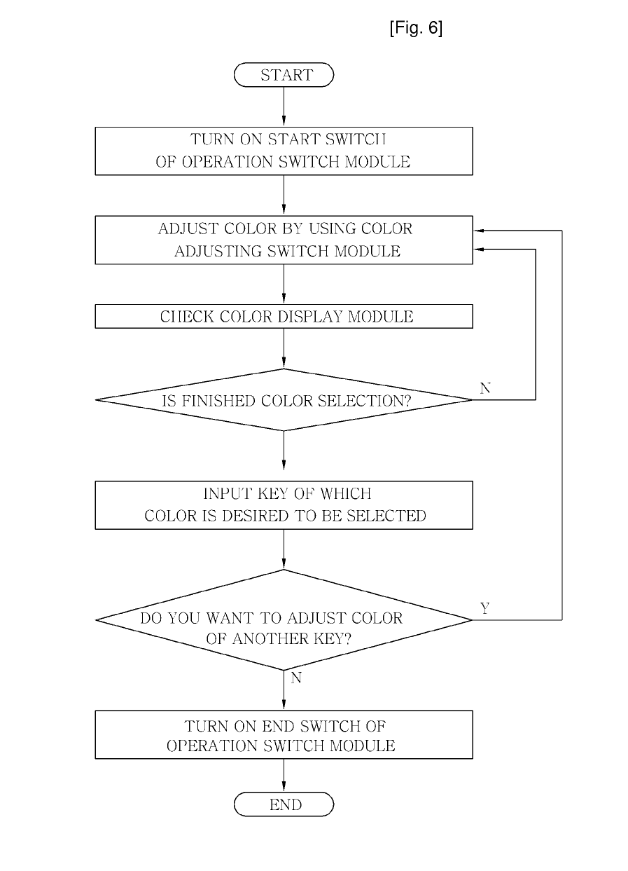

FIG. 6 is a view illustrating another example of the method of selecting a color of each key in the first embodiment of the present invention.

Alternatively, unlike in the above-mentioned embodiment, a key of which color is desired to be selected may not be selected beforehand (Step S2). That is, as shown in FIG. 6, after the start switch is operated (Step S11), a color is adjusted using the color switch module (Step S12), a color display module is checked (Step S13), and the color adjustment is finished (S14), the key of which color is desired to be selected may be input (Step S15).

Resetting may be performed using the reset switch 42c in order to delete the stored color and select another color for each key 11.

After a color of each key 11 is adjusted, the color adjustment program 32a stored in the microcomputer 30 controls the LEDs 20a, 20b, and 20c below each key 11 so that the selected colors can be displayed on the keys.

That is, according to the present invention, the color adjustment program 32a for adjusting a color is stored in the microcomputer 30 that is integrally formed with the keyboard input device 1, and the color adjusting unit 40 for selecting a color of each key is also integrally formed with the keyboard input device 1. In addition, the color display module 43 for adjusting a color is also included in the color adjusting unit 40 that is integrally formed with the keyboard input device 1.

Therefore, regardless of a connected unit such as a computer or an IPTV, it is possible to independently operate the color adjusting switch module 42 by using the only keyboard input device 1, to select a color of each key 11 while a user sees the color displayed on the color display module 43, and to control the LEDs 20a, 20b, and 20c of each key 11 by using the microcomputer 30 so that the selected color is displayed.

As a result, even if the connected unit is replaced or substituted after a color of each key is selected on the keyboard input device, it is possible to use the keyboard input device without installing and executing a separate color selection program on a connected unit in order to select a color of each key.

### MODE FOR THE INVENTION

### Second Embodiment

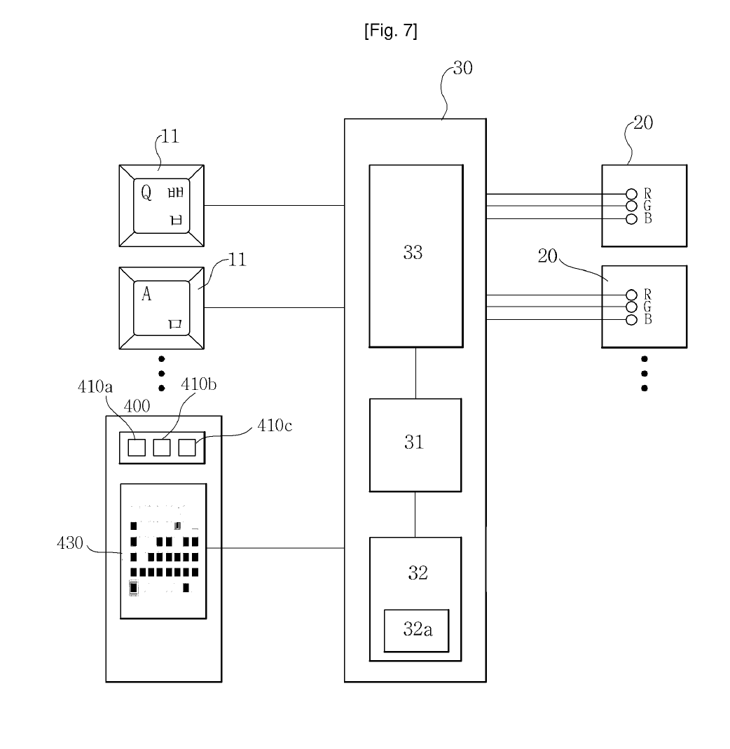

FIG. 7 is a view showing the configuration of a keyboard input device according to a second embodiment of the present invention.

A keyboard input device according to a second embodiment of the present invention is the same as that according to the first embodiment in terms of the basic configuration. In this case, the basic configuration includes a keyboard unit 10, a light-emitting element 20 that is provided below each key 11 of the keyboard unit 10, a microcomputer 30 that controls a color of the light-emitting element 20, and a color adjusting unit 40 that is connected to the microcomputer 30 and adjusts the color of the light-emitting element 20 corresponding to each key 11.

However, in comparison with the first embodiment, the second embodiment is different from the first embodiment in that an algorithm for displaying a color table is included in the color adjustment program 32a stored in the microcomputer 30, and in that the color adjusting unit 40 has different configuration.

A color adjusting unit 400 of the second embodiment includes a touch panel module 430 and an operation switch module 410 that is provided above the touch panel module 430.

A color table is displayed on the touch panel module 430. When a portion of the color table corresponding to a desired color is touched by a pen or a finger, the desired color is selected.

Colors are selected by the color adjusting switch module 42 provided at the lower portion of the color adjusting unit 40 in the first embodiment. In contrast, the color adjusting switch module 42 is not provided in the second embodiment. The second embodiment is different from the first embodiment in that a color of a key is selected by touching the touch panel module 430.

The operation switch module 410 is connected to the microcomputer 30. The operation switch module includes a start switch 410a that is used to start the color adjustment of each key 11, an end switch 410b that is used to finish the color adjustment when the color adjustment is finished, and a reset switch 410c that is used to reset the selected color adjustment.

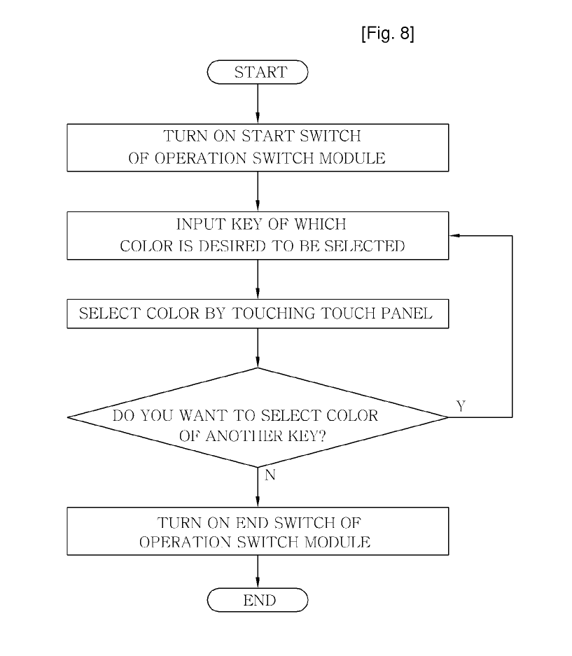

FIG. 8 is a view illustrating a method of selecting a color of each key in the second embodiment of the present invention.

First, the start switch 410a of the operation switch module 410 is operated in the color adjusting unit 400 (Step S21).

Then, a key of which color is desired to be selected is input (Step SS2), and a desired color is selected by touching a desired color of the color table displayed on the touch panel module 430 (Step S23). It is possible to easily select a desired color by selecting one among various colors of the color table.

When the color selection of the key 11 is finished (Step S23), the contents of the color selection of the former key are stored if another key is pushed to select a color of another key 11 (Step S24). Color adjustment is performed with respect to another key in the same way. Then, when the color adjustment is performed with respect to all of the desired keys, the end switch 420b is operated to finish the color adjustment (Step S25).

Like another example of the method of selecting a color of a key in the first embodiment, a key of which color is desired to be selected may be selected after a desired color is selected by touching a desired color of the color table displayed on the touch panel module 430.

The keyboard input devices according to the first and second embodiments of the present invention have described as a keyboard input device for a computer, but is not limited thereto. The keyboard input devices according to the first and second embodiments of the present invention may be applied to any one, such as a keyboard for an IPTV or a key pad of a mobile phone, as long as the keyboard includes a plurality of keys.

### INDUSTRIAL APPLICABILITY

The keyboard input device according to present invention can independently select and display colors of keys regardless of a connected unit such as a computer or an IPTV. Therefore, a separate drive program does not need to be installed and executed to select the colors of the keys.

1-9. (canceled)

10. A keyboard input device that includes a plurality of keys connected to a computer, an IPTV, or other electronic device, the keyboard input device comprising:
light-emitting elements disposed below a plurality of keys, each element including a plurality of LEDs configured to illuminate upper surfaces of the keys;
a microcomputer configured to control the colors of the light-emitting elements by controlling the plurality of LEDs; and
a color adjusting unit connected to the microcomputer, the color adjusting unit including an operation switch module configured to control a start and an end of color adjustment and a color adjusting switch module configured to adjust the colors of the keys by adjusting the colors of the plurality of LEDs.

11. The keyboard input device according to claim 10, wherein the operation switch module includes a start switch, an end switch, and a reset switch, and wherein the color adjusting switch module includes a red-color adjusting switch, a green-color adjusting switch, and a blue-color adjusting switch that adjust the brightness of the colors.

12. The keyboard input device according to claim 10, wherein the color adjusting unit further includes a color display module that displays the colors adjusted by the color adjusting switch module.

13. The keyboard input device according to claim 12, wherein the color display module includes a display part that is made of a transparent material and a light-emitting element that includes a plurality of LEDs disposed below the display part.

14. The keyboard input device according to claim 10, wherein the operation switch module includes at least one key in the keyboard input device.

15. The keyboard input device according to claim 10, wherein the color adjusting switch module includes at least one key in the keyboard input device.

16. The keyboard input device according to claim 10, wherein a color adjustment program for driving the color adjusting unit is stored in the microcomputer.

17. A keyboard input device that includes a plurality of keys connected to a computer, an IPTV, or other electronic device, the keyboard input device comprising:
light-emitting elements disposed below a plurality of keys, each element including a plurality of LEDs configured to illuminate upper surfaces of the keys;
a microcomputer configured to control the colors of the light-emitting elements by controlling the plurality of LEDs; and
a color adjusting unit connected to the microcomputer, the color adjusting unit configured to adjust the colors of the keys by adjusting the colors of the plurality of LEDs, the color adjusting unit including an operation switch module configured to control a start and an end of the color adjustment, the color adjusting unit including a color display module that displays a color table of having various colors, and the color adjusting unit configured for selection of colors.

18. The keyboard input device according to claim 17, wherein the operation switch module includes a start switch, an end switch, and a reset switch, and wherein the color display module includes a touch panel configured to allow color selection.

19. The keyboard input device according to claim 17, wherein the operation switch module includes at least one key in the keyboard input device.

20. The keyboard input device according to claims 17, wherein the color adjusting switch module includes at least one key in the keyboard input device.

21. The keyboard input device according to claim 17, wherein a color adjustment program for driving the color adjusting unit is stored in the microcomputer.

22. A method of selecting a color of a key by using the keyboard input device, the method comprising the steps of:
a) operating a chosen input key on a keyboard to select a desired color for the chosen input key, wherein the keyboard includes:
light-emitting elements disposed below a plurality of keys, each element including a plurality of LEDs configured to illuminate upper surfaces of the keys,
a microcomputer configured to control the colors of the light-emitting elements by controlling the plurality of LEDs, and
a color adjusting unit connected to the microcomputer, the color adjusting unit including an operation switch module configured to control a start and an end of color adjustment and a color adjusting switch module configured to adjust the colors of the keys by adjusting the colors of the plurality of LEDs;
b) adjusting the desired color of the chosen input key by using the color adjusting unit, transmitting a signal corresponding to the adjusted color to the color display module, and adjusting the color while a user sees the displayed color; and
c) controlling LEDs, which are disposed below the chosen input key, with the microcomputer so that the adjusted color is displayed by the chosen input key.

23. The method according to claim 22, wherein the step (b) is performed before the step (a).
